(19) United States
(12) Patent Application Publication
(10) Pub. No.: US 2010/0088737 A1
(43) Pub. Date: Apr. 8, 2010

(54) INFORMATION PROCESSING DEVICE AND CONTROL METHOD

(75) Inventor: Toshiro OHBITSU, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/542,161

(22) Filed: Aug. 17, 2009

(30) Foreign Application Priority Data
Oct. 2, 2008 (JP) 2008-257628

(51) Int. Cl. H04N 7/173

(52) U.S. Cl. 725/133

(57) ABSTRACT

An information processing device including, a receiving unit to receive video data from a server, a reproducing unit to reproduce the received video data and to display a video on a displaying unit, and a transmitting unit to transmit, to said server, a video title of the video data reproduced by the reproducing unit and reproducing time information representing a period of reproducing time of the video data reproduced by the reproducing unit.

### CROSS-REFERENCE TO RELATED APPLICATIONS

This application is based upon and claims the benefit of prior Japanese Patent Application No. 2008-257628 filed on Oct. 2, 2008, the entire contents of which are incorporated herein by reference.

### FIELD

The embodiment relates to a technology of reproducing video data and sound (including voice) data.

### BACKGROUND

Over the recent years, a general type of information device such as a personal computer is equipped with a function enabling a connection to the Internet to be established as well as a function of reproducing the video data and the sound data that are recorded on a recording medium like a DVD (Digital Versatile Disk) etc. Then, it is also a general practice to produce a recording medium recorded with video information of a commercial video etc of a not-yet-exhibited movie.

The information device equipped with the function of reproducing the video data and the sound data reproduces the video information recorded on the recording medium, whereby a user views the video information (for example, Japanese National Publication of International Patent Application No. 2005-530294, Japanese Laid-Open Patent Publication No. 2006-33873).

### SUMMARY

A video information provider has hitherto provided the user with the recording medium recorded with the video information but has been required to perform a market research based on a questionnaire research etc in order to know a reaction from the user who viewed the video information.

According to an aspect of the embodiment, an information processing device includes, a receiving unit to receive video data from a server, a reproducing unit to reproduce the received video data and to display a video on a displaying unit, and a transmitting unit to transmit, to said server, a video title of the video data reproduced by the reproducing unit and reproducing time information representing a period of reproducing time of the video data reproduced by the reproducing unit.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF THE DRAWINGS

FIG. 1 is a block diagram illustrating a system architecture in the embodiment.

FIG. 2 is a diagram illustrating a hardware configuration of a terminal device 1.

FIG. 3 is a function block diagram of the terminal device 1.

FIG. 4 is a flowchart illustrating a processing flow of the terminal device 1 and distribution servers 2A, 2B and 2C.

FIG. 5 is a flowchart illustrating a processing flow of the terminal device 1 and the distribution servers 2A, 2B and 2C.

FIG. 6 is a flowchart illustrating a processing flow of the terminal device 1 and the distribution servers 2A, 2B and 2C.

FIG. 7 is a diagram illustrating one example of an alarm screen displayed on a display device 17.

FIG. 8 is a diagram illustrating one example of a main menu screen displayed on the display device 17.

FIG. 9 is a diagram illustrating one example of a title menu screen displayed on the display device 17.

FIG. 10 is a diagram illustrating one example of the title menu screen displayed on the display device 17.

FIG. 11 is a diagram illustrating one example of a specified product check screen displayed on the display device 17.

FIG. 12 is a diagram illustrating one example of an alarm screen displayed on the display device 17.

### DESCRIPTION OF EMBODIMENT

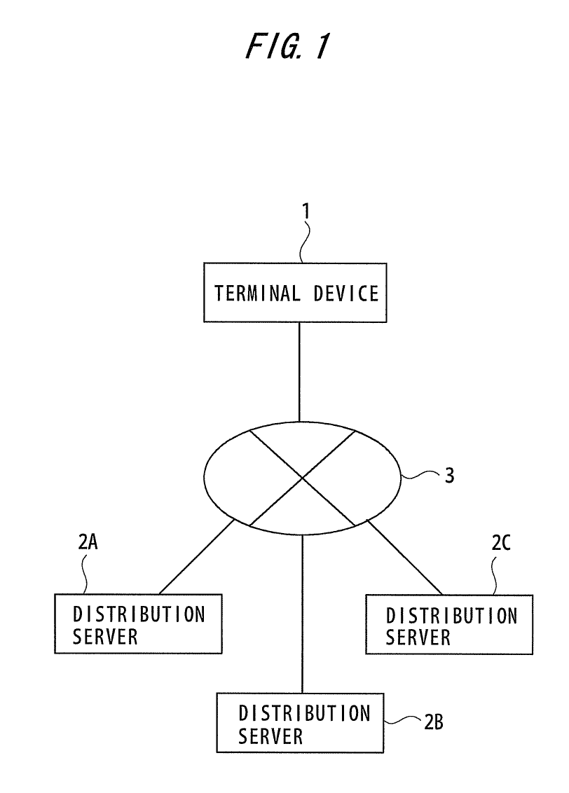

FIG. 1 is the block diagram illustrating the system architecture in the embodiment. The system includes a terminal device 1 and distribution servers 2A, 2B, 2C. FIG. 1 illustrates an exemplification, and the numbers of the terminal device 1 and the distribution servers 2A, 2B, 2C are not limited to those given herein.

The terminal device 1 is defined as an information processing device connectable to a network 3, such as a personal computer, a Personal Digital Assistant (PDA), a mobile phone and Consumer Electronics (CE) appliances.

The distribution servers 2A, 2B, 2C are defined as information management devices connectable to the network 3, such as the personal computer, a workstation and a mainframe. A Web site for providing a predetermined category of information to the terminal device 1 is set up on each of the distribution servers 2A, 2B, 2C.

The network 3 is exemplified by the Internet and a local area network (LAN). Further, the network 3 may be also built up by a communication line such as a telephone line, a private line, an optical communication network and a communication satellite.

The terminal device 1 and the distribution server 2A exchange the information with each other via the network 3. The terminal device 1 and the distribution server 2B exchange the information with each other via the network 3. The terminal device 1 and the distribution server 2C exchange the information with each other via the network 3.

The terminal device 1 establishes the connections to the distribution servers 2A, 2B, 2C via the network 3 and accesses the Web sites set up by the distribution servers 2A, 2B, 2C.

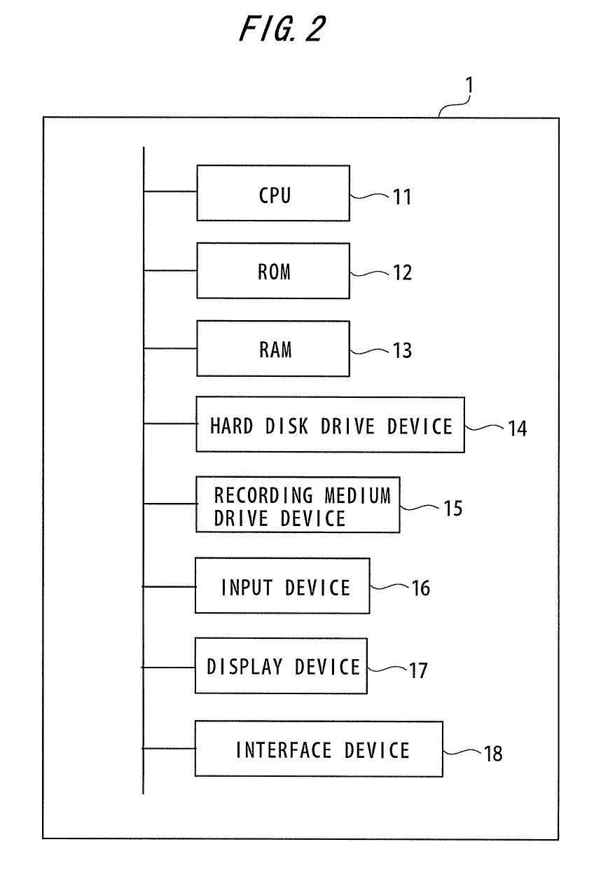

FIG. 2 is the diagram depicting the hardware configuration of the terminal device 1 in a case where the terminal device 1 is realized as the personal computer.

The terminal device 1 includes a CPU (Central Processing Unit) 11, a ROM (Read Only Memory) 12, a RAM (Random Access Memory) 13, a hard disk drive device 14, a recording medium drive device 15, an input device 16, a display device 17 and an interface device 18. The CPU 11, the ROM 12, the RAM 13, the hard disk drive device 14, the recording medium drive device 15, the input device 16, the display device 17 and the interface device 18 are connected with each other via a bus.

The CPU 11 executes a variety of processes according to a program stored in the ROM 12. The CPU 11 establishes the communication lines with the distribution servers 2A, 2B, 2C through the interface device 18. The interface device 18 is provided with communication devices such as a MODEM and a terminal adaptor, and controls the communications with the distribution servers 2A, 2B, 2C.

The ROM 12 is stored with programs, parameters, etc used for the CPU 11 to execute the variety of processes. The ROM 12 is stored with a communication program for establishing and maintaining the communication with, e.g., the distribution servers 2A, 2B, 2C.

The RAM 13 is temporarily stored with data necessary for the CPU 11 to operate and with application programs executed by the CPU 11.

The hard disk drive device 14 executes writing and reading to and from a hard disk (unillustrated). The hard disk is stored with a program loaded into the RAM 13. Further, the hard disk is stored with the data processed by the CPU 11.

The recording medium drive device 15 is a device for driving the recording medium. The recording medium is exemplified by, e.g., a CD (Compact Disc), the DVD, a HD-DVD, a Blu-ray disc, a flash memory, etc. Moreover, the recording medium drive device 15 may also be an input/output device for a card medium including a nonvolatile memory like the flash memory.

The input device 16 is operated when inputting a predetermined command and necessary data. The input device 16 is exemplified by, e.g., a keyboard, a mouse, a pointing device, a wireless remote controller and so on.

The display device 17 displays the data processed by the CPU 11 and the data stored in the RAM 13. The video data read from the recording medium is processed by the CPU 11 and the RAM 13, and displayed on the display device 17. Further, the pieces of video data received from the distribution servers 2A, 2B, 2C are processed by the CPU 11 and the RAM 13 and displayed on the display device 17. The display device 17 is exemplified by such as a liquid crystal display device, a plasma display panel, a CRT (Cathode Ray Tube) and an electro luminescence panel.

The terminal device 1 acquires the video data from the distribution servers 2A, 2B, 2C. The video data includes the sound data. Moreover, a picture contains a dynamic image and a static image. The terminal device 1 may also acquire the video data from the distribution servers 2A, 2B, 2C via the network 3.

Furthermore, the terminal device 1 may also acquire the video data from the recording medium by installing the recording medium recorded with the video data into the recording medium drive device 15 provided in the terminal device 1. Each of the distribution servers 2A, 2B, 2C may also record the video data directly on the recording medium, and the video data provided by the distribution servers 2A, 2B, 2C may be recorded on the recording medium by other methods. The recording medium recorded with the video data may be transferred to the terminal device 1 from each of the distribution servers 2A, 2B, 2C by way of assignment such as selling and distribution.

The video data recoded on the recording medium is reproduced by the terminal device 1, thereby enabling a user of the terminal device 1 to view the video. Further, the video data distributed from each of the distribution servers 2A, 2B, 2C is reproduced by the terminal device 1, whereby the user of the terminal device 1 views the video.

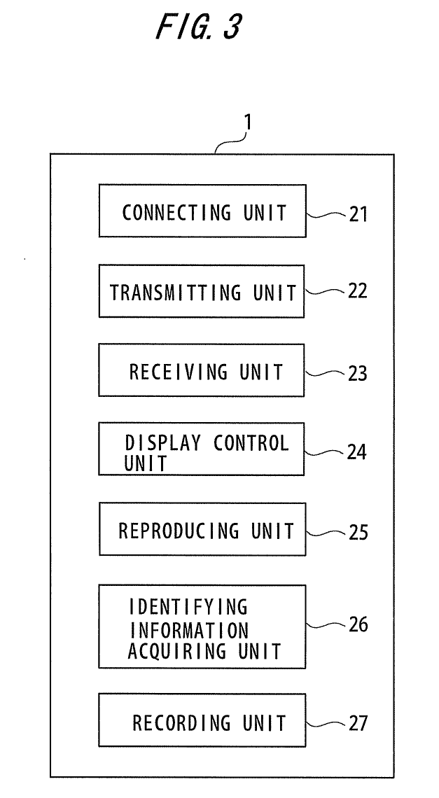

FIG. 3 is the function block diagram of the terminal device 1. The terminal device 1 includes a connecting unit 21, a transmitting unit 22, a receiving unit 23, a display control unit 24, a reproducing unit 25, an identifying information acquiring unit 26 and a recording unit 27. These function units may be realized by the computer including the CPU 11, the ROM 12, the RAM 13, etc and by the programs etc executed on the computer.

The Browser stored in the ROM 12 is executed by the CPU 11 and the RAM 13, whereby the function as the connecting unit 21 may be realized. The communication program stored in the ROM 12 is executed by the CPU 11 and the RAM 13, whereby the functions as the transmitting unit 22 and the receiving unit 23 may be actualized. A video reproducing application stored in the ROM 12 is executed by the CPU 11 and the RAM 13, whereby the functions as the display control unit 24, the reproducing unit 25 and the identifying information acquiring unit 26 may be actualized.

Further, the connecting unit 21, the transmitting unit 22, the receiving unit 23, the display control unit 24, the reproducing unit 25 and the identifying information acquiring unit 26 may also be realized as dedicated processors.

The connecting unit 21 connects the terminal device 1 to the network 3. The transmitting unit 22 transmits the various categories of information and the various items of data to the distribution servers 2A, 2B, 2C via the network 3. The receiving unit 23 receives the various categories of information and the various items of data from the distribution servers 2A, 2B, 2C via the network 3.

The display control unit 24 displays an alarm screen, a provider selecting screen, a normal video selecting screen, a privilege video selecting screen and a specified product check screen on the display device 17. The reproducing unit 25 reproduces the normal video data, thereby displaying a normal video on the display device 17. Further, the reproducing unit 25 reproduces a privilege video data, thereby displaying a privilege video on the display device 17. The identifying information acquiring unit 26 acquires identifying information of the terminal device 1. The recording unit 27 is recorded with various categories of information and various items of data.

<Processing Flow>

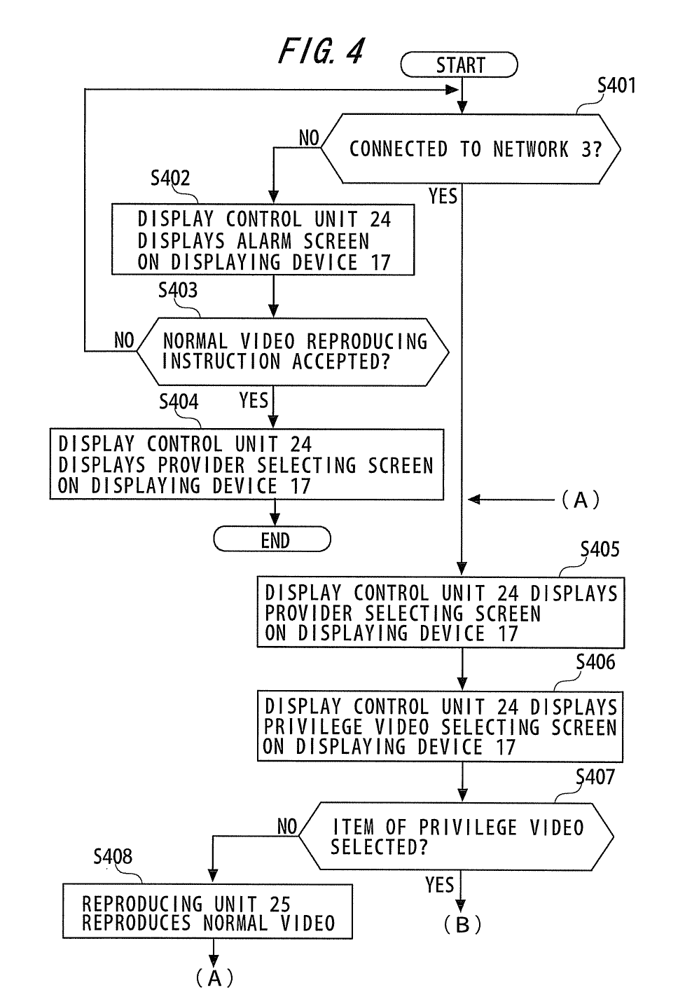

Processes of the terminal device 1, the distribution servers 2A, 2B, 2C will be described with reference to FIGS. 4 through 6. FIGS. 4 through 6 are flowcharts which illustrate processing flows of the terminal device 1 and the distribution servers 2A, 2B, 2C.

The processes illustrated in FIGS. 4 through 6 are based on a premise that the recording medium recorded with the information on the normal video data and the video data is loaded into the recording medium drive device 15. The “information on the video data” connotes information for displaying, e.g., the alarm screen, the provider selecting screen, the normal video selecting screen, the privilege video selecting screen and the specified product check screen on the display device 17. Further, the processes illustrated in FIGS. 4 through 6 are executed, e.g., when the reproducing unit 25 is started up.

The reproducing unit 25 queries the connecting unit 21 and thus determines whether the terminal device 1 is connected to the network 3 or not (S401).

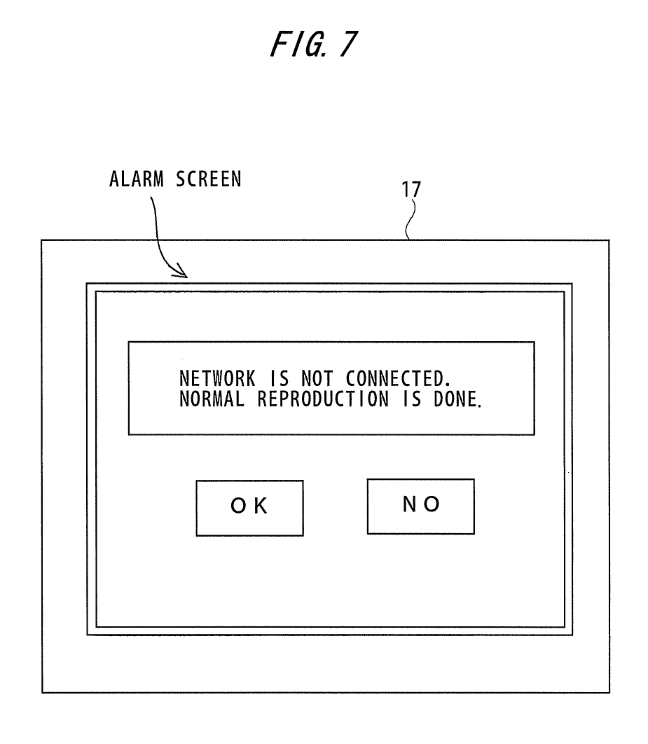

If the terminal device 1 is not connected to the network 3 (No in the process of S401), the display control unit 24 displays the alarm screen on the display device 17 (S402). For example, if the terminal device 1 is not connected to the network 3, the display control unit 24 displays the alarm screen depicted in FIG. 7 on the display device 17.

FIG. 7 is the diagram illustrating one example of the alarm screen displayed on the display device 17. The user recognizes that the terminal device 1 is not connected to the network 3 in a way that checks the alarm screen illustrated in FIG. 7. The user performs the operation of connecting the terminal device 1 to the network 3 via the input device 16. The connecting unit 21, when accepting the network connecting operation of the terminal device 1 from the user via the input device 16, connects the terminal device 1 to the network 3.

The discussion will get back to the description in FIG. 4. The reproducing unit 25 determines whether a normal video reproducing instruction given from the user is accepted or not (S403). If “OK” on the alarm screen illustrated in FIG. 7 is selected via the input device 16, the reproducing unit 25 may decide that the normal video reproducing instruction from the user has been accepted. If “NO” on the alarm screen illustrated in FIG. 7 is selected via the input device 16, the reproducing unit 25 may decide that the normal video reproducing instruction from the user is not yet accepted.

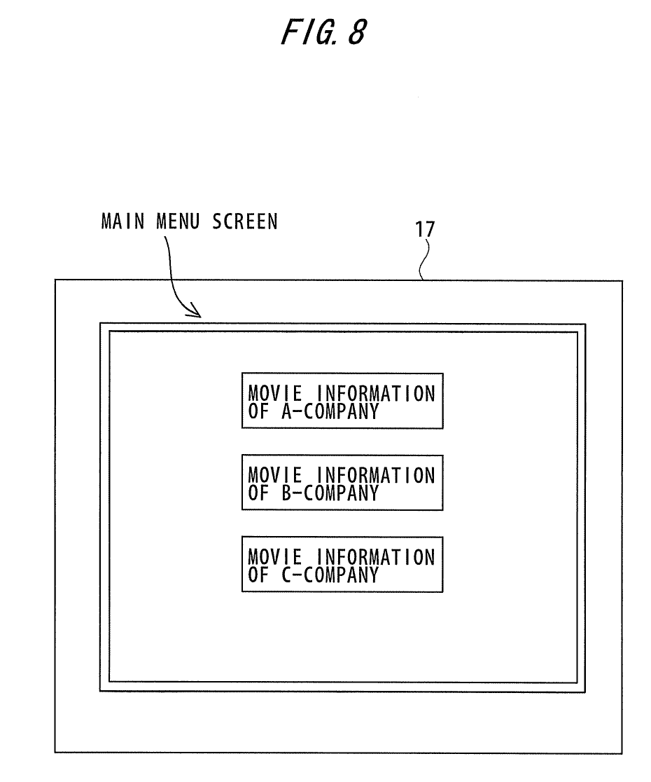

The discussion gets again back to the description in FIG. 4. When the reproducing unit 25 decides that the normal video reproducing instruction from the user has been accepted (YES in the process of S403), the display control unit 24 displays the provider selecting screen on the display device 17 (S404). For instance, the display control unit 24 displays the main menu screen depicted in FIG. 8 on the display device 17.

FIG. 8 is the diagram illustrating one example of the main menu screen displayed on the display device 17. As illustrated in FIG. 8, items displayed on the main menu screen are [Movie information of the A-company], [Movie information of the B-company] and [Movie information of the C-company], which can be selected through the input device 16.

Herein, an assumption is that the A-company administers the distribution server 2A, the B-company administers the distribution server 2B and the C-company administers the distribution server 2C. This is, however, an exemplification, and the A-company, the B-company and the C-company may entrust the administration of the distribution servers 2A, 2B, 2C to other companies.

The user selects, via the input device 16, any one of the items of [Movie information of the A-company], [Movie information of the B-company] and [Movie information of the C-company] on the main menu screen illustrated in FIG. 8. The user, when desiring to view the movie information of the A-company, selects via the input device 16 the item of the [Movie information of the A-company] on the main menu screen depicted in FIG. 8.

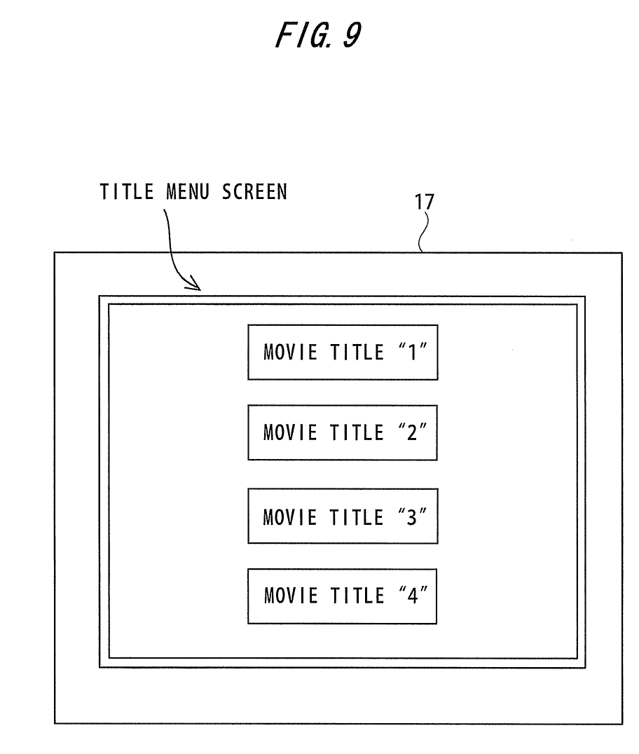

If the item of the [Movie information of the A-company] on the main menu screen depicted in FIG. 8 is selected, the display control unit 24 displays the normal video selecting screen on the display device 17. For example, the display control unit 24 displays the title menu screen illustrated in FIG. 9 on the display device 17.

FIG. 9 is the diagram illustrating one example of the title menu screen displayed on the display device 17. As illustrated in FIG. 9, items displayed on the title menu screen are [Movie title “1”], [Movie title “2”], [Movie title “3”] and [Movie title “4”], which can be selected through the input device 16. The item of the movie title displayed on the title menu screen is a title of the movie provided by the A-company. Herein, the pieces of video data of the movie title “1”, movie title “2”, movie title “3” and movie title “4” are defined as the normal video data.

The user selects, through the input device 16, any one of the items of [Movie title “1”], [Movie title “2”], [Movie title “3”] and [Movie title “4”] on the title menu screen illustrated in FIG. 9. The user, when desiring to view the video of the movie title “1” on the title menu screen depicted in FIG. 9, selects via the input device 16 the item of the [Movie title “1”] on the title menu screen depicted in FIG. 9.

If the item of [Movie title “1”] illustrated in FIG. 9 is selected, the reproducing unit 25 reproduces the video data of the movie title “1”. The reproducing unit 25 reproduces the video data of the movie title “1”, whereby the video of the movie title “1” is displayed on the display device 17. When the user finishes viewing the normal video, the processes illustrated in FIGS. 4 through 6 are terminated.

While on the other hand, if the reproducing unit 25 determines that the normal video reproducing instruction given from the user is not accepted (NO in the process in S403), the control of the terminal device 1 loops back to the process in S401.

If the terminal device 1 is connected to the network 3 (YES in the process in S401), the display control unit 24 displays the provider selecting screen on the display device 17 (S405). For instance, the display control unit 24 displays the main menu screen illustrated in FIG. 8 on the display device 17.

The user selects, through the input device 16, any one of the items such as [Movie information of the A-company], [Movie information of the B-company] and [Movie information of the C-company] on the main menu screen depicted in FIG. 8. The user, when desiring to view the movie information of the A-company, selects the item of [Movie information of the A-company] on the main menu screen illustrated in FIG. 8.

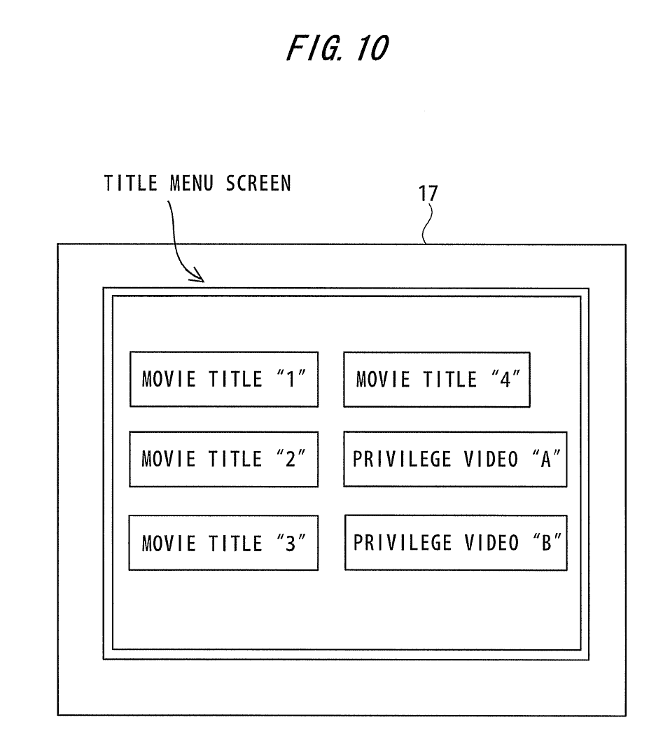

The discussion gets again back to the description in FIG. 4. The display control unit 24 displays the privilege video selecting screen related to the selected provider on the display device 17 (S406). For example, if the item of [Movie information of the A-company] on the main menu screen illustrated in FIG. 8 is selected, the display control unit 24 displays the title menu screen depicted in FIG. 10 on the display device 17.

FIG. 10 is the diagram illustrating one example of the title menu screen displayed on the display device 17. As depicted in FIG. 10, items displayed on the title menu screen are [Movie title “1”], [Movie title “2”], [Movie title “3”], [Movie title “4”], [Privilege video “A”] and [Privilege video “B”], which can be selected via the input device 16. The item of the movie title displayed on the title menu screen illustrated in FIG. 10 is a title of the movie provided by the A-company. The item of the privilege video displayed on the title menu screen depicted in FIG. 10 is a name (title) of the privilege video provided by the A-company.

The discussion gets again back to the description in FIG. 4. The reproducing unit 25 determines whether or not the item of the privilege video on the privilege video selecting screen is selected (S407). For instance, if the item of [Privilege video “A”] or [Privilege video “B”] on the title menu screen illustrated in FIG. 10 is selected, the reproducing unit 25 may determine that the item of the privilege video on the privilege video selecting screen is selected. Further, e.g., when selecting any one of the items such as [Movie title “1”], [Movie title “2”], [Movie title “3”] and [Movie title “4”] on the title menu screen illustrated in FIG. 10, the reproducing unit 25 may also determine that none of the items of the privilege videos on the privilege video selecting screen are selected.

The discussion gets again back to the description in FIG. 4. If none of the items of the privilege videos on the privilege video selecting screen are selected (NO in the process in S407), the reproducing unit 25 reproduces the normal video data (S408).

For instance, if the item of [Movie title “1”] on the title menu screen illustrated in FIG. 10 is selected, the reproducing unit 25 reproduces the video data of the movie title “1”. The reproducing unit 25 reproduces the video data of the movie title “1”, whereby the video related to the movie title “1” is displayed on the display device 17. When the reproducing unit 25 finishes reproducing the normal video data, the control of the terminal device 1 advances to the process in S405 (see (A) in FIG. 4).

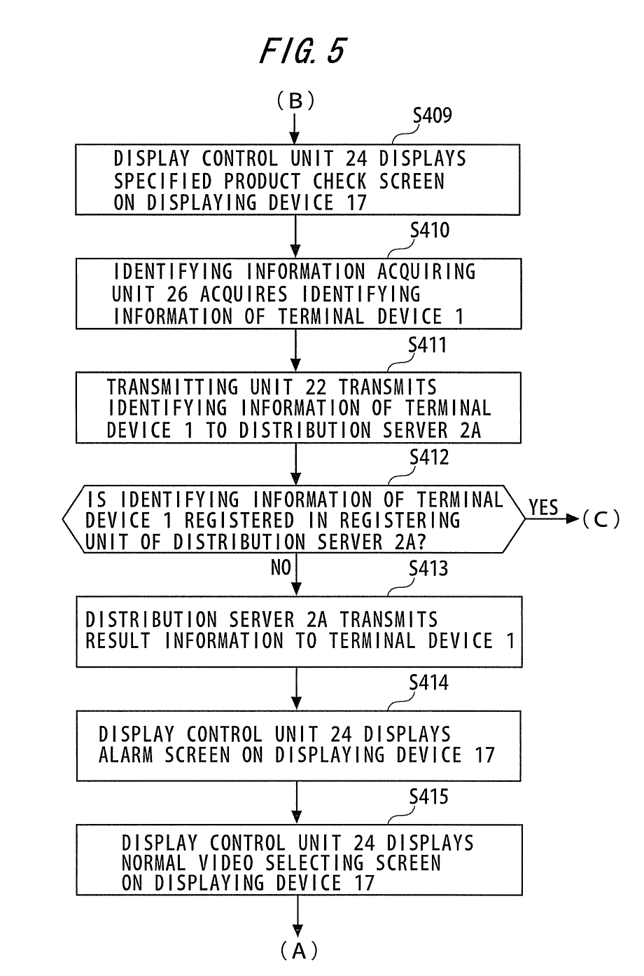

While on the other hand, if the item of the privilege video on the privilege video selecting screen is selected (YES in the process in S407), the display control unit 24 displays the specified product check screen on the display device 17 (S409, and see (B) in FIGS. 4 and 5). A check item concerning an agreement (AGREE) on the transmission of the identifying information of the terminal device 1 to the distribution server 2A is displayed on the specified product check screen.

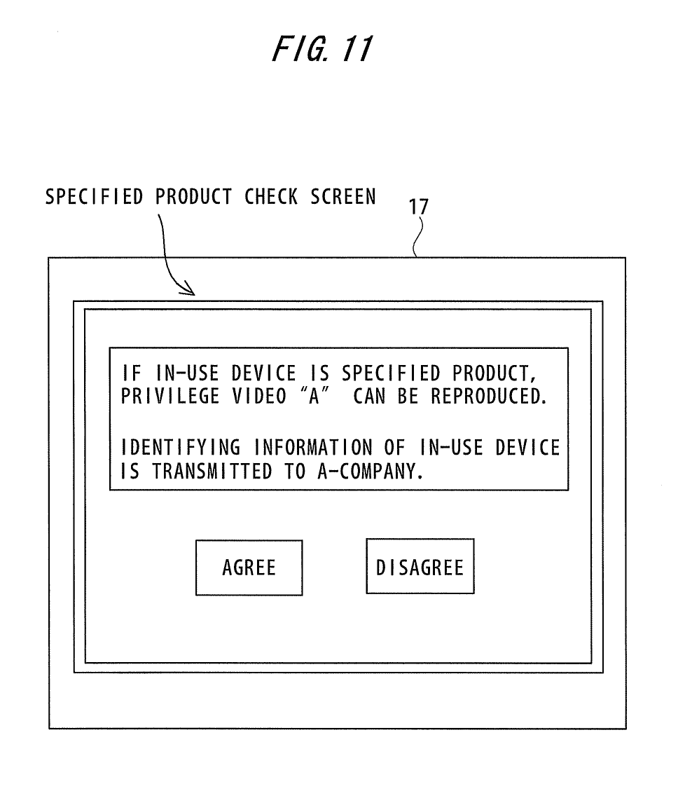

For example, if the item of [Privilege video “A”] on the title menu screen illustrated in FIG. 10 is selected, the display control unit 24 displays the specified product check screen depicted in FIG. 11 on the display device 17.

FIG. 11 is the diagram illustrating one example of the specified product check screen displayed on the display device 17. The user visually recognizes the specified product check screen depicted in FIG. 11 and thus recognizes, if the terminal device 1 is defined as the specified product, that the user can view the privilege video.

The user, when agreeing on the transmission of the identifying information of the terminal device 1 to the distribution server 2A, selects the agreement (AGREE) on the specified product check screen illustrated in FIG. 11 through the input device 16. The user, when disagreeing on the transmission of the identifying information of the terminal device 1 to the distribution server 2A, selects a disagreement (DISAGREE) on the specified product check screen illustrated in FIG. 11 via the input device 16.

The discussion returns to the explanation in FIG. 5. In the case of selecting the agreement on the specified product check screen illustrated in FIG. 11 via the input device 16, the identifying information acquiring unit 26 acquires the identifying information of the terminal device 1 (S410). Note that the disagreement on the specified product check screen depicted in FIG. 11 is selected through the input device 16, and the control of the terminal device 1 advances to S405 in FIG. 4.

Herein, a process of how the identifying information acquiring unit 26 acquires the identifying information of the terminal device 1 will be described. To begin with, the identifying information acquiring unit 26 takes out the information of the BIOS (Basic Input Output System) stored in the ROM 12. The identifying information acquiring unit 26 extracts the identifying information of the terminal device 1 from the BIOS information taken out of the ROM 12. For example, the identifying information of the terminal device 1 is exemplified such as a name of a manufacturing company, a serial number and a product number of the terminal device 1. The identifying information of the terminal device 1 is information registered by the manufacturing company of the terminal device 1. Moreover, the identifying information of the terminal device 1 may be rewritten only the manufacturing company of the terminal device 1.

The discussion returns again to the explanation in FIG. 5. The transmitting unit 22 transmits the identifying information of the terminal device 1 to the distribution server 2A via the network 3 (S411).

The distribution server 2A receives the identifying information of the terminal device 1 via the network 3 from the terminal device 1. The distribution server 2A determines whether or not the identifying information of the terminal device 1 is registered in a registering unit of the distribution server 2A (S412). The registering unit of the distribution server 2A is, e.g., a RAM and a ROM provided in the distribution server 2A.

If the identifying information of the terminal device 1 is not registered in the registering unit of the distribution server 2A (NO in the process in S412), the distribution server 2A transmits a piece of result information containing reproduction unapproved information to the terminal device 1 (S413). The reproduction unapproved information is information representing that the reproduction of the privilege video data is not approved.

The receiving unit 23 receives the result information containing the reproduction unapproved information from the distribution server 2A via the network 3. When the receiving unit 23 receives the result information containing the reproduction unapproved information, the display control unit 24 displays the alarm screen on the display device 17 (S414). When the receiving unit 23 receives the result information containing the reproduction unapproved information, the reproducing unit 25 does not reproduce the privilege video.

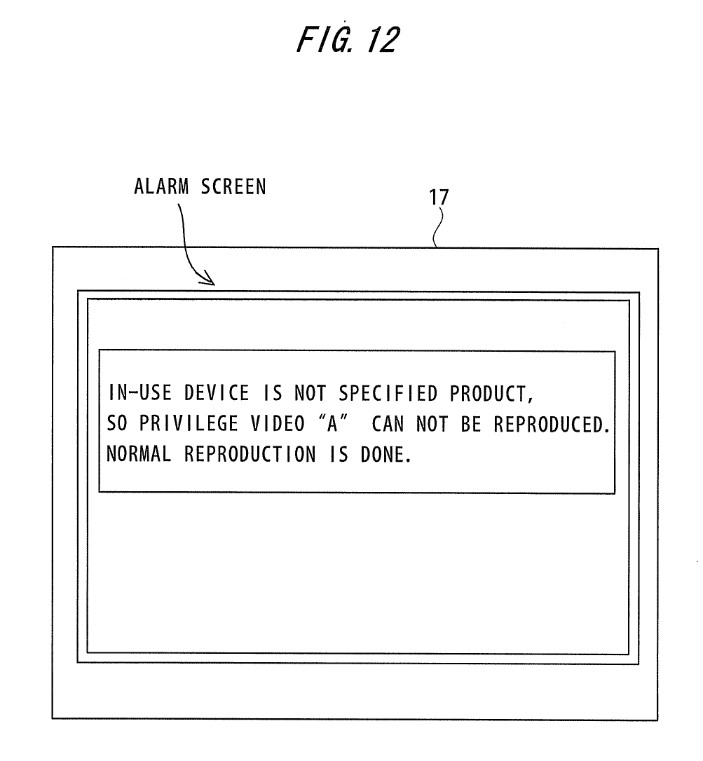

For instance, when the receiving unit 23 receives the result information containing the reproduction unapproved information, the display control unit 24 displays the alarm screen illustrated in FIG. 12 on the display device 17. FIG. 12 is the diagram illustrating one example of the alarm screen displayed on the display device 17.

The user recognizes that the privilege video can not be viewed in a way that checks the alarm screen depicted in FIG. 12. A specified device is approved to view the privilege video, thereby enabling the accesses to the distribution server 2A from unspecified devices to be restrained.

The discussion returns again to the explanation in FIG. 5. The display control unit 24 displays the normal video data selecting screen on the display device 17 (S415). For example, the display control unit 24 displays the title menu screen illustrated in FIG. 9 on the display device 17.

The user selects any one of [Movie title “1”], [Movie title “2”], [Movie title “3”] and [Movie title “4”] on the title menu screen illustrated in FIG. 9 via the input device 16. The user, in the case of desiring to view the video of the movie title “1”, selects the item of [Movie title “1”] on the title menu screen depicted in FIG. 9. When the item of [Movie title “1”] on the title menu screen illustrated in FIG. 9 is selected, the reproducing unit 25 reproduces the video data of the movie title “1”. The reproducing unit 25 reproduces the video data of the movie title “1”, whereby the video of the movie title “1” is displayed on the display device 17.

When the reproducing unit 25 finishes reproducing the normal video data, the control of the terminal device 1 loops back to the process in S405 (see (A) in FIGS. 4 and 5).,

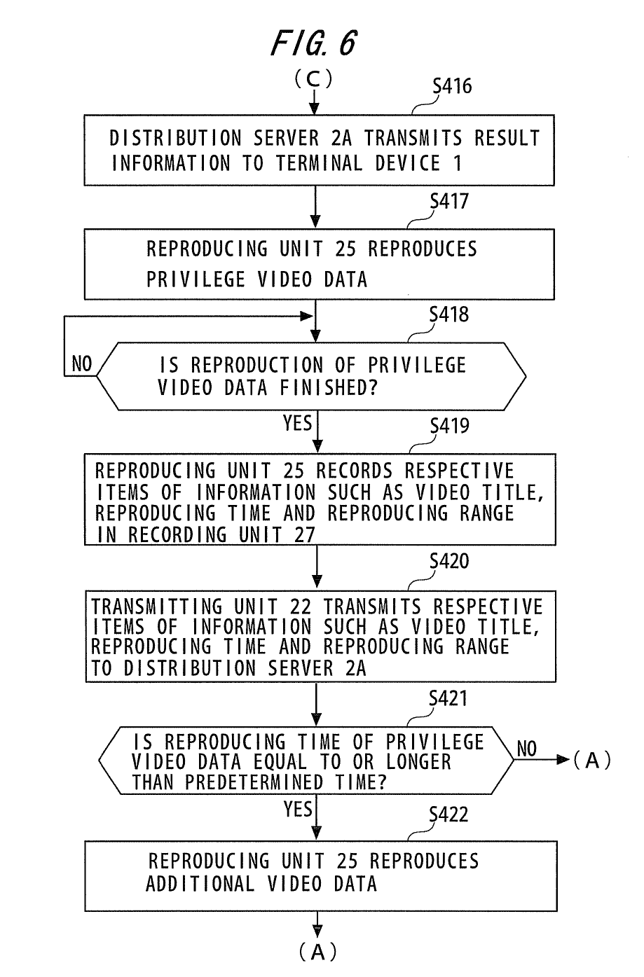

While on the other hand, if the identifying information of the terminal device 1 is registered in the registering unit of the distribution server 2A (YES in the process in S412), the distribution server 2A transmits the result information containing a piece of reproduction approved information via the network 3 to the terminal device 1 (S416, and see (C) in FIGS. 5 and 6). The reproduction approved information is information representing that the reproduction of the privilege video data is approved.

The receiving unit 23 receives via the network 3 the result information containing the reproduction approved information from the distribution server 2A. When the receiving unit 23 receives the result information containing the reproduction approved information, the reproducing unit 25 reproduces the privilege video data (S417). To be specific, the receiving unit 23 receives the privilege video data from the distribution server 2A via the network 3, whereby the reproducing unit 25 reproduces the privilege video data. The reproducing unit 25 may perform stream reproduction of the privilege video data.

If the item of [Privilege video “A”] on the title menu screen illustrated in FIG. 10 is selected, the reproducing unit 25 reproduces the privilege video data of the privilege video “A”. The reproducing unit 25 reproduces the privilege video data of the privilege video “A”, thereby displaying the video of the privilege video “A” on the display device 17.

The discussion gets back to the description in FIG. 6. The reproducing unit 25 determines whether the reproduction of the privilege video data is finished or not (S418). If the reproduction of the privilege video data is not yet finished (NO in the process in S418), the reproducing unit 25 repeats the process in S418.

Whereas if the reproduction of the privilege video data is finished (YES in the process in S418), the reproducing unit 25 records, in the recording unit 27, the video name (title) information of the privilege video data that has been reproduced. Further, the reproducing unit 25 records, in the recording unit 27, respective items of information about reproducing time and a reproducing range of the privilege video data that has been reproduced (S419).

The reproducing time is an elapse period of time till a point of time when finishing the reproduction of the privilege video data since a point of time when starting the reproduction of the privilege video data. For instance, when starting the reproduction of the privilege video data from the beginning and finishing halfway the reproduction of the privilege video data, the reproducing time of the privilege video data is shorter than the total time of the privilege video data. The reproducing range represents a range from a position (starting frame) of the privilege video data at the point of time when starting the reproduction of the privilege video data up to a position (ending frame) of the privilege video data at the point of time when ending the reproduction of the privilege video data. Namely, the reproducing range defines the reproduced frames of the privilege video data, which correspond to the viewed frames of the privilege video, which were viewed by the user of the terminal device 1.

The transmitting unit 22 transmits, to the distribution server 2A via the network 3, the respective items of information such as the video title of the privilege video data, the reproducing time of the privilege video data and the reproducing range of the privilege video data recorded in the recording unit 27 (S420). The distribution server 2A receives the respective items of information such as the video title of the privilege video data, the reproducing time of the privilege video data and the reproducing range of the privilege video data from the terminal device 1 via the network 3.

Next, the reproducing unit 25 determines whether the reproducing time of the privilege video data is equal to or longer than a predetermined period of time (S421). If the reproducing time of the privilege video data is equal to or longer than a predetermined period of time (YES in the process in S421), the reproducing unit 25 reproduces additional video data (S422). Specifically, the receiving unit 23 receives the additional video data from the distribution server 2A via the network 3, whereby the reproducing unit 25 reproduces the additional video data. The reproducing unit 25 may also conduct the stream reproduction of the additional video data. The reproducing unit 25 reproduces the additional video data, thereby displaying the additional video on the display device 17. The additional video may also be a further privilege video.

The distribution server 2A may transmit to the terminal device 1 the additional video data corresponding to the reproducing time of the privilege video data. For example, the distribution server 2A may transmit, to the terminal device 1, the additional video data of which content differs in a case of having a shorter period of reproducing time of the privilege video data and in a case of having a longer period of reproducing time thereof.

In the process in S422 of FIG. 6, when finishing the reproduction of the additional video data, the control of the terminal device 1 loops back to the process in S405 (see (A) in FIGS. 4 and 6). Further, if the reproducing time of the privilege video data is shorter than the predetermined period of time (NO in the process in S421), the control of the terminal device 1 loops back to the process in S405 (see (A) is FIGS. 4 and 6).

The processes between the terminal device 1 and the distribution server 2A have been described in FIGS. 4 through 12. The processes between the terminal device 1 and the distribution servers 2B and 2C can be executed in the same way as the processes between the terminal device 1 and the distribution server 2A are done.

Each of the distribution servers 2A, 2B and 2C receives, from the terminal device 1, the information on the video title of the privilege video data that has been reproduced. It is therefore feasible for the privilege video provider to grasp what type of privilege video the user of the terminal device 1 has an interest in.

Moreover, the distribution servers 2A, 2B and 2C receive, from a plurality of information devices, the information on the video titles of the privilege video data that have been reproduced. This scheme enables the privilege video provider to statistically grasp what types of privilege videos the viewers of the privilege videos have the interest in.

Each of the distribution servers 2A, 2B and 2C receives, from the terminal device 1, the respective items of information such as the video title of the reproduced privilege video data and the reproducing time of the privilege video data. It is therefore possible for the privilege video provider to grasp how long the user of the terminal device 1 continues to have the interest in the privilege video.

Further, the distribution servers 2A, 2B and 2C receive, from the plurality of information devices, the respective items of information such as the video title of the reproduced privilege video data and the reproducing time of the privilege video data. This scheme enables the privilege video provider to statistically grasp how long the viewers of the privilege videos continue to have the interest in the privilege videos.

Each of the distribution servers 2A, 2B and 2C receives, from the terminal device 1, the respective items of information such as the video title of the reproduced privilege video data and the reproducing range of the privilege video data. Therefore, the privilege video provider grasps which scene of the privilege video the user of the terminal device 1 has the interest in.

Moreover, the distribution servers 2A, 2B and 2C receive, from the plurality of information devices, the respective items of information such as the video title of the reproduced privilege video data and the reproducing range of the privilege video data. This scheme enables the privilege video provider to statistically grasp which scenes of the privilege videos the viewers of the privilege videos have the interest in.

Each of the distribution servers 2A, 2B and 2C receives, from the terminal device 1, the respective items of information such as the video title of the reproduced privilege video data, the reproducing time of the privilege video data and the reproducing range of the privilege video data. Hence, the privilege video provider grasps how much an impact of the video scene the user of the terminal device 1 has the interest in is. Namely, the privilege video provider grasps how long and which scene of the privilege video the user of the terminal device 1 continues to have the interest in.

Further, the distribution servers 2A, 2B and 2C receive, from the plurality of information devices, the respective items of information such as the video title of the reproduced privilege video data, the reproducing time of the privilege video data and the reproducing range of the privilege video data. With this scheme, the privilege video provider statistically grasps how much the impact of the video scenes the viewers of the privilege videos have the interest in is. Namely, the privilege video provider statically grasps how long and which scenes of the privilege videos the viewers continue to have the interest in.

Thus, the privilege video provider acquires the data with higher reliability by use of the simple system than by grasping the viewing state through a questionnaire research etc. Moreover, the user of the terminal device 1 can view the privilege video, and both of the privilege video provider and the viewer of the privilege video can obtain beneficial information.

The embodiment has discussed the example of the case of reproducing the privilege video and may be, without being limited to this case, applied to a case of reproducing music and sounds (voices).

The embodiment has discussed the example of conducting the reproduction of the privilege video data in the case that the identifying information of the terminal device 1 is registered in the registering unit of the distribution server 2A. Without being limited to this example, however, the privilege video data may also be reproduced irrespective of whether the identifying information of the terminal device 1 is registered in the registering unit of the distribution server 2A or not.

The embodiment has exemplified the example in which the receiving unit 23 receives the privilege video data from the distribution server 2A, and the reproducing unit 25 reproduces the privilege video data. Without being limited to this example, an available scheme is that the privilege video data is recorded on the recording medium, and the reproducing unit 25 reproduces the privilege video data recorded on the recording medium.

For instance, in the processes explained in FIGS. 4 through 6, the recording medium loaded into the recording medium drive device 15 may be configured as a recording medium recorded with the normal video data, the information on the video data and the privilege video data. Then, in the process in S417 of FIG. 6, the reproducing unit 25 may reproduce the privilege video data by reading the privilege video data from the recording medium. In this case, the receiving unit 23 may not receive the privilege video data from the distribution server 2A.

### MODIFIED EXAMPLE

In the embodiment discussed above, each of the distribution servers 2A, 2B and 2C receives the identifying information of the terminal device 1 via the network 3 from the terminal device 1. Further, in the embodiment discussed above, each of the distribution servers 2A, 2B and 2C receives the information of the video title of the reproduced privilege video data via the network 3 from the terminal device 1. The modified example may include modifying the embodiment discussed above in the way that follows.

To be specific, the distribution servers 2A, 2B and 2C may register, in the registering units of the distribution servers 2A, 2B and 2C, the identifying information of the terminal device 1 and the video title of the reproduced privilege video data in the way of being associated with each other. Then, the terminal device 1 may be inhibited from reproducing again the video data specified by the video title registered in the registering unit of each of the distribution servers 2A, 2B and 2C.

For instance, in the process in S412 of FIG. 5, the distribution server 2A may further determine whether or not the identifying information of the terminal device 1 and the video title of the reproduced privilege video data are registered in the registering unit of the distribution server 2 in the way of being associated with each other. Then, if the identifying information of the terminal device 1 and the video title of the reproduced privilege video data are registered in the registering unit of the distribution server 2 in the way of being associated with each other, the distribution server 2 may transmit the result information containing the reproduction unapproved information to the transmission terminal 1 via the network 3.

Furthermore, an available scheme is that the receiving unit 23 receives the result information containing the reproduction unapproved information from the distribution server 2 via the network 3, and the display control unit 24 displays the alarm screen on the display device 17. It may be sufficient that a message representing that the privilege video can not be again viewed is displayed on the alarm screen in this case. When the receiving unit 23 receives the result information containing the reproduction unapproved information via the network 3 from the distribution server 2, the reproducing unit 25 does not reproduce again the privilege video data.

According to the modified example, it is possible to inhibit the terminal device 1 from reproducing the same privilege video data a plural number of times. With this contrivance, the privilege video provider acquires the data with the much higher reliability.

In the information processing device according to the embodiment, the video title of the video data reproduced by the reproducing unit and the reproducing time information representing the reproducing time of the video data reproduced by the reproducing unit, are transmitted to the server. Therefore, the provider providing the video data acquires the video title of the video data reproduced by the reproducing unit and the reproducing time information representing the reproducing time of the video data reproduced by the reproducing unit. As a result, the provider providing the video data knows the viewing state of the user who views the video displayed on the displaying unit.

The embodiment may also be a method by which a computer, other devices, machines, etc execute any one of the processes described above. Further, the embodiment may also be a program for making the computer, other devices, machines, etc execute any one of the processes described above. Still further, the embodiment may also be a computer readable recording medium with the program, which can be read by the computer etc.

### Computer Readable Recording Medium

It is possible to record a program which causes a computer to implement any of the functions described above on a computer readable recording medium. By causing the computer to read in the program from the recording medium and execute it, the function thereof can be provided. The computer readable recording medium mentioned herein indicates a recording medium which stores information such as data and a program by an electric, magnetic, optical, mechanical, or chemical operation and allows the stored information to be read from the computer. Of such recording media, those detachable from the computer include, e.g., a flexible disk, a magneto-optical disk, a CD-ROM, a CD-R/W, a DVD, a DAT, an 8-mm tape, and a memory card. Of such recording media, those fixed to the computer include a hard disk and a ROM (Read Only Memory).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present inventions has been described in detail, it should be understood that the various changes, substitutions, and alterations could be made hereto without departing from the spirit and scope of the invention.

What is claimed is:

1. An information processing device comprising:
a receiving unit to receive video data from a server;
a reproducing unit to reproduce the received video data and to display a video on a displaying unit; and
a transmitting unit to transmit, to said server, a video title of the video data reproduced by the reproducing unit and reproducing time information representing a period of reproducing time of the video data reproduced by the reproducing unit.

2. The information processing device according to claim 1, wherein the transmitting unit transmits, to the server, reproducing range information representing a reproducing range of the video data reproduced by the reproducing unit.

3. The information processing device according to claim 1, further comprising:
an identifying information acquiring unit to acquire identifying information of a self-device,
wherein the transmitting unit transmits the identifying information to the server,
the receiving unit receives result information from the server, and
the reproducing unit, if the received result information contains information representing an approval for reproducing the video data, reproduces the received video data.

4. A control method of an information processing device comprising:
receiving video data from a server;
displaying a video on a displaying unit by reproducing the received video data; and
transmitting, to the server, a video title of the reproduced video data and reproducing time information representing a period of reproducing time of the reproduced video data.

5. The control method according to claim 4, further comprising transmitting, to the server, reproducing range information representing a reproducing range of the reproduced video data.

6. The control method according to claim 4, further comprising acquiring identifying information of the information processing device;
transmitting the identifying information to the server;
receiving result information from the server; and
reproducing, if the received result information contains information representing approval for reproducing the video data, the received video data.

7. A computer readable recording medium storing a control program of an information processing device, the control program causing the information processing device to execute a method, the method comprising:
receiving video data from a server;
displaying a video on a displaying unit by reproducing the received video data; and
transmitting, to the server, a video title of the reproduced video data and reproducing time information representing a period of reproducing time of the reproduced video data.

8. The computer readable recording medium storing the control program according to claim 7, the method further comprising transmitting, to the server, reproducing range information representing a reproducing range of the reproduced video data.

9. The computer readable recording medium storing the control program according to claim 7, the method further comprising acquiring identifying information of the information processing device;
transmitting the identifying information to the server;
receiving result information from the server; and
reproducing, if the received result information contains information representing approval for reproducing the video data, the received video data.
